(19) United States
(12) Patent Application Publication
(10) Pub. No.: US 2009/0195758 A1
(43) Pub. Date: Aug. 6, 2009

(54) MESHES FOR SEPARATELY MAPPING COLOR BANDS

(75) Inventors: Irwin E. Sobel, Menlo Park, CA (US); Laurence M. Hubby, JR., Palo Alto, CA (US); Ian N. Robinson, Pebble Beach, CA (US); Daniel George Gelb, Redwood City, CA (US); Michael Harville, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P.

(21) Appl. No.: 12/023,938

(22) Filed: Jan. 31, 2008

(51) Int. Cl. G03B 21/14

(52) U.S. Cl. 353/69; 382/285

(57) ABSTRACT

A method includes generating a first plurality of meshes configured to map a first domain associated with a display surface to a second domain associated with an image capture device configured to capture a first image of the display surface, and generating a second plurality of meshes configured to map the second domain to a third domain associated with a first projector configured to display a second image onto the display surface. A third plurality of meshes is generated using the first plurality of meshes and the second plurality of meshes. The third plurality of meshes is configured to separately map a plurality of color bands between the first domain and the third domain.

### CROSS-REFERENCE TO RELATED APPLICATION

This application is related to U.S. patent application Ser. No. 11/455,306, attorney docket no. 200601999-1, filed on Jun. 16, 2006, and entitled MESH FOR RENDERING AN IMAGE FRAME, which is hereby incorporated by reference herein.

### BACKGROUND

Many cameras that capture images have planar image planes to produce planar images. Planar images captured by such cameras may be reproduced onto planar surfaces. When a viewer views a planar image that has been reproduced onto a planar surface, the viewer generally perceives the image as being undistorted, assuming no keystone distortion, even when the viewer views the image at oblique angles to the planar surface of the image. If a planar image is reproduced onto a non-planar surface (e.g., a curved surface) without any image correction, the viewer generally perceives the image as being distorted.

Display systems that reproduce images in tiled positions may provide immersive visual experiences for viewers. While tiled displays may be constructed from multiple, abutting display devices, these tiled displays generally produce undesirable seams between the display devices that may detract from the experience. In addition, because these display systems generally display planar images, the tiled images may appear distorted and unaligned if displayed on a non-planar surface without correction. In addition, the display of the images with multiple display devices may be inconsistent because of the display differences between the devices.

### SUMMARY

One form of the present invention provides a method that includes generating a first plurality of meshes configured to map a first domain associated with a display surface to a second domain associated with an image capture device configured to capture a first image of the display surface, and generating a second plurality of meshes configured to map the second domain to a third domain associated with a first projector configured to display a second image onto the display surface. A third plurality of meshes is generated using the first plurality of meshes and the second plurality of meshes. The third plurality of meshes is configured to separately map a plurality of color bands between the first domain and the third domain.

### BRIEF DESCRIPTION OF THE DRAWINGS

FIG. 1A is a block diagram illustrating an image display system according to one embodiment.

FIG. 1B is a schematic diagram illustrating a developable surface according to one embodiment.

FIG. 1C is a schematic diagram illustrating the projection of partially overlapping images onto a developable surface without correction according to one embodiment.

FIG. 1D is a schematic diagram illustrating the projection of partially overlapping images onto a developable surface with correction according to one embodiment.

FIGS. 2A-2H are flow charts illustrating methods for geometric correction according to one embodiment.

FIGS. 3A-3D are schematic diagrams illustrating the generation of screen-to-camera triangle meshes according to one embodiment.

FIGS. 4A-4D are schematic diagrams illustrating the generation of camera-to-projector triangle meshes according to one embodiment.

FIGS. 5A-5B are schematic diagrams illustrating the generation and use of a screen-to-projector a triangle mesh for each projector in an image display system according to one embodiment.

FIGS. 6A-6D are flow charts illustrating methods for chromatic aberration correction according to one embodiment.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” etc., may be used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

I. Generation and Display of Partially Overlapping Frames onto a Surface

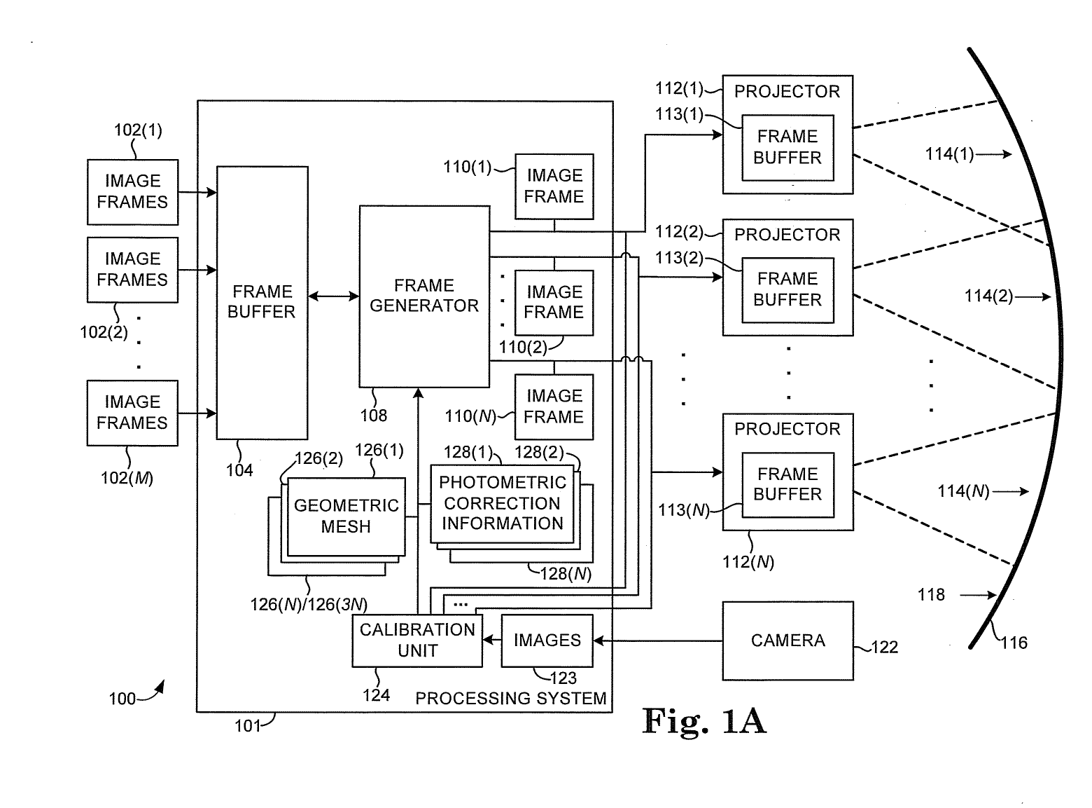

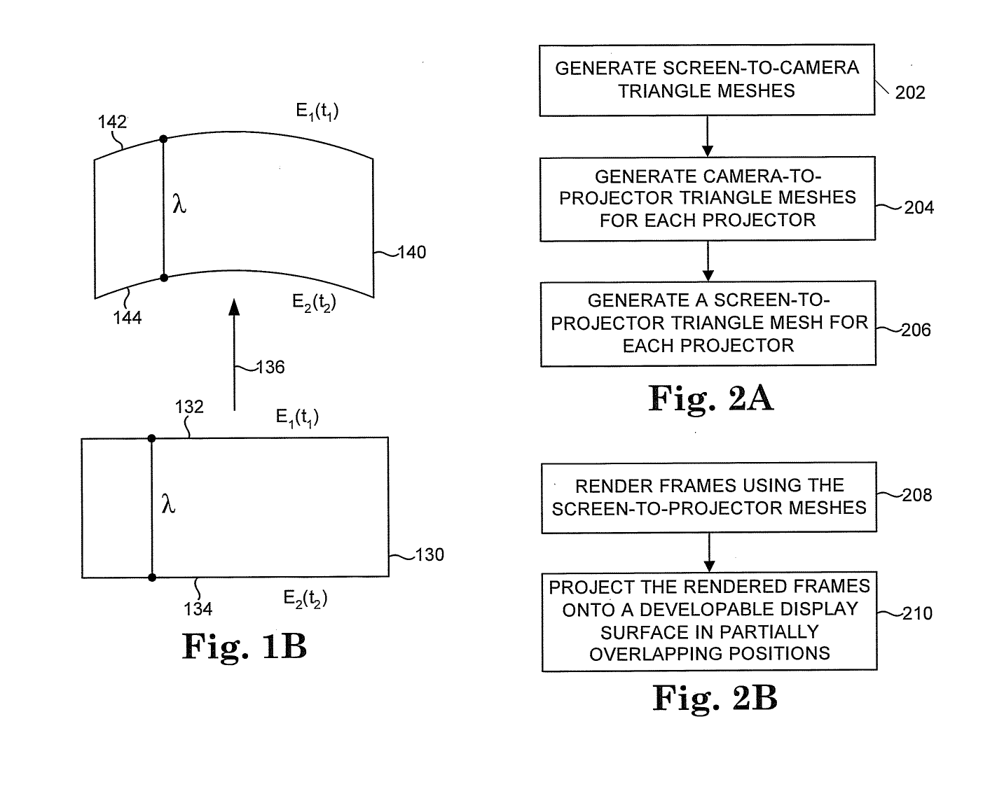

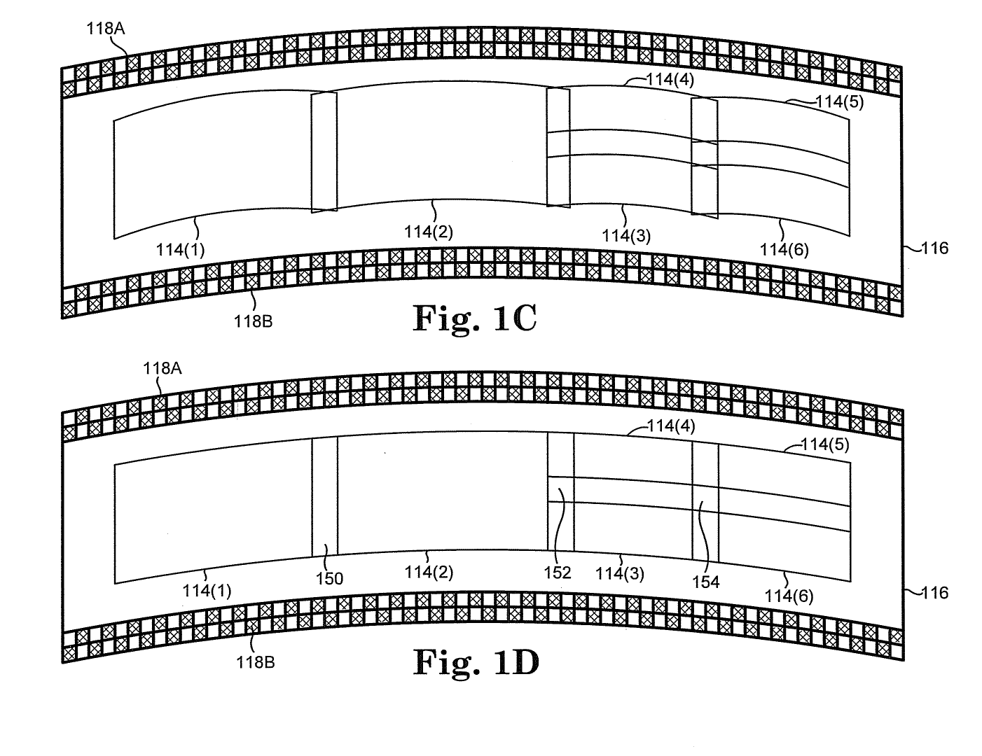

FIG. 1A is a block diagram illustrating an image display system 100 according to one embodiment. Image display system 100 includes a processing system 101, projectors 112(1) through 112(N) where N is greater than or equal to one (collectively referred to as projectors 112), and at least one camera 122. Processing system 101 includes image frame buffer 104, frame generator 108, and calibration unit 124.

Processing system 101 receives streams of image frames 102(1) through 102(M) where M is greater than or equal to one (referred to collectively as image frames 102) using any suitable wired or wireless connections including any suitable network connection or connections. The streams of image frames 102(1) through 102(M) may be captured and transmitted by attached or remote image capture devices (not shown) such as cameras, provided by an attached or remote storage medium such as a hard-drive, a DVD or a CD-ROM, or otherwise accessed from one or more storage devices by processing system 101.

In one embodiment, a first image capture device captures and transmits image frames 102(1), a second image capture device captures and transmits image frames 102(2), and an Mth image capture device captures and transmits image frames 102(M), etc. The image capture devices may be arranged in one or more remote locations and may transmit the streams of image frames 102(1) through 102(M) across one or more networks (not shown) using one or more network connections.

In one embodiment, the number M of streams of image frames 102 is equal to the number N of projectors 112. In other embodiments, the number M of streams of image frames 102 is greater than or less than the number N of projectors 112.

Image frames 102 may be in any suitable video or still image format such as MPEG-2 (Moving Picture Experts Group), MPEG-4, JPEG (Joint Photographic Experts Group), JPEG 2000, TIFF (Tagged Image File Format), BMP (bit mapped format), RAW, PNG (Portable Network Graphics), GIF (Graphic Interchange Format), XPM (X Window System), SVG (Scalable Vector Graphics), and PPM (Portable Pixel Map).

Image frame buffer 104 receives and buffers image frames 102. Frame generator 108 processes buffered image frames 102 to form image frames 110(1) through 110(N) (collectively referred to as image frames 110). In one embodiment, frame generator 108 processes a single stream of image frames 102 to form one or more image frames 110. In other embodiments, frame generator 108 processes multiple streams of image frames 102 to form one or more image frames 110.

In one embodiment, frame generator 108 processes image frames 102 to define image frames 110(1) through 110(N) using respective geometric meshes 126(1) through 126(N) (collectively referred to as geometric meshes 126) and respective photometric correction information 128(1) through 128(N) (collectively referred to as photometric correction information 128). Frame generator 108 provides frames 110(1) through 110(N) to projectors 112(1) through 112(N), respectively.

Projectors 112(1) through 112(N) store frames 110(1) through 110(N) in image frame buffers 113(1) through 113(N) (collectively referred to as image frame buffers 113), respectively. Projectors 112(1) through 112(N) project frames 110(1) through 110(N), respectively, onto display surface 116 to produce projected images 114(1) through 114(N) (collectively referred to as projected images 114) for viewing by one or more users. In one embodiment, projectors 112 project frames 110 such that each displayed image 114 at least partially overlaps with another displayed image 114. Thus, image display system 100 according to one embodiment displays images 114 in at least partially overlapping positions (e.g., in a tiled format) on display surface 116.

Projected images 114 are defined to include any combination of pictorial, graphical, or textural characters, symbols, illustrations, or other representations of information. Projected images 114 may be still images, video images, or any combination of still and video images.

Display surface 116 includes any suitable surface configured to display images 114. In one or more embodiments described herein, display surface 116 forms a developable surface. As used herein, the term developable surface is defined as a surface that is formed by folding, bending, cutting, and otherwise manipulating a planar sheet of material without stretching the sheet. A developable surface may be planar, piecewise planar, or non-planar. A developable surface may form a shape such as a cylindrical section or a parabolic section. Non-planar developable display surfaces may allow a viewer to feel immersed in the projected scene. In addition, such surfaces may fill most or all of a viewer's field of view which allows scenes to be viewed as if they are at the same scale as they would be seen in the real world. As described in additional detail below, image display system 100 according to one embodiment is configured to display projected images 114 onto a developable surface without geometric distortion and without chromatic aberrations.

By displaying images 114 onto a developable surface, images 114 are projected to appear as if they have been “wallpapered” to the developable surface where no pixels of images 114 are stretched. The wallpaper-like appearance of images 114 on a developable surface appears to a viewer to be undistorted.

A developable surface can be described by the motion of a straight line segment through three-dimensional (3D) space. FIG. 1B is a schematic diagram illustrating a planar surface 130. As shown in FIG. 1B, planar surface 130 is a shape that can be created by moving a straight line segment λ through 3D space. E₁(t₁) and E₂(t₂) represent endpoint curves 132 and 134 traced by the movement of the endpoints of the line segment λ. Endpoint curves 132 and 134 swept out in 3D space by the endpoints of the line segment λ are sufficient to define the entire surface 130. With planar developable surface 130, endpoint curves 132 and 134 are straight, parallel lines.

When planar surface 130 is curved into a non-planar developable surface 140 without stretching as indicated by an arrow 136, the straight endpoint curves 132 and 134 become curved endpoint curves 142 and 144 in the example of FIG. 1B. Curving planar surface 130 into non-planar surface 140 may be thought of as analogous to bending, folding, or wallpapering planar surface 130 onto a curved surface without stretching. Endpoint curves 142 and 144 swept out in 3D space by the endpoints of the line segment λ are sufficient to define the entire surface 140.

Image display system 100 may be configured to construct a two-dimensional (2D) coordinate system corresponding to planar surface 130 from which non-planar surface 140 was created using a predetermined arrangement of identifiable points in fiducial marks on display surface 116. The geometry of the predetermined arrangement of identifiable points may be described according to distance measurements between the identifiable points. The distances between a predetermined arrangement of points may all be scaled by a single scale factor without affecting the relative geometry of the points, and hence the scale of the distances between the points on display surface 116 does not need to be measured. In the embodiment shown in FIG. 1B, the predetermined arrangement of points lie in fiducial marks along the curved endpoint curves E₁(t₁) and E₂(t₂) in display surface 116. These endpoint curves define a 2D coordinate system in the planar surface 130 created by flattening curved display surface 140. Specifically, E₁ (t₁) and E₂(t₂) are parallel in surface 130, with the connecting line segment λ lying in the orthogonal direction at each t.

In one embodiment, image display system 100 displays images 114 on display surface 116 with a minimum amount of distortion and chromatic aberrations, smooth brightness levels, and a smooth color gamut. To do so, frame generator 108 applies geometric and photometric correction to image frames 102 using geometric meshes 126 and photometric correction information 128, respectively, in the process of rendering frames 110. Geometric correction is described in additional detail in Section II below, chromatic aberration correction is described in additional detail in Section III below, and photometric correction is described in additional detail in U.S. patent application Ser. No. 11/455,306, attorney docket no. 200601999-1, filed on Jun. 16, 2006, and entitled MESH FOR RENDERING AN IMAGE FRAME, which is incorporated by reference.

Frame generator 108 may perform any suitable image decompression, color processing, and conversion on image frames 102. For example, frame generator 108 may convert image frames 102 from the YUV-4:2:0 format of an MPEG2 video stream to an RGB format. In addition, frame generator 108 may transform image frames 102 using a matrix multiply to translate, rotate, or scale image frames 102 prior to rendering. Frame generator 108 may perform any image decompression, color processing, color conversion, or image transforms prior to rendering image frames 102 with geometric meshes 126 and photometric correction information 128.

Calibration unit 124 generates geometric meshes 126 and photometric correction information 128 using images 123 captured by at least one camera 122 during a calibration process. Camera 122 may be any suitable image capture device configured to capture images 123 of display surface 116. Camera 122 captures images 123 such that the images include fiducial marks 118 (shown as fiducial marker strips 118A and 118B in FIGS. 1C and 1D) on display surface 116. Fiducial marks 118 may be any suitable pattern or set of patterns that include a set of points with predetermined arrangement of the points where the patterns are recognizable by a pattern recognition algorithm. Fiducial marks 118 may be permanently attached to display surface 116 or may be applied to display surface 116 only during the calibration process. Calibration unit 124 uses the predetermined arrangement of points to create a mapping of display surface 116. The predetermined arrangement of identifiable points may be described by distance measurements between the identifiable points in the 2D space of flattened display surface 116, where the scale of the distance measurements is not necessarily known. Fiducial marks 118 may be located outside of the display area on display surface 116 where images 114 will appear when displayed by projectors 112. In the embodiment shown in FIGS. 1C and 1D, fiducial marker strips 118A and 118B form black and white checkerboard patterns at the top and bottom of display surface 116 where the distance between the corners of the checkerboard patterns in the horizontal direction is known by image display system 100. In other embodiments, fiducial marks 118 may form any other suitable pattern. In further embodiments, fiducial marks 118 may also consist of active light emitters, such as LEDs, lasers, or infrared light sources. These light sources may optionally be deactivated during display of images 114 on display surface 116.

In one embodiment, camera 122 includes a single camera configured to capture images 123 that each include the entirety of display surface 116. In other embodiments, camera 122 includes multiple cameras each configured to capture images 123 that include a portion of display surface 116 where the combined images 123 of the multiple cameras include the entirety of display surface 116.

FIG. 1C is a schematic diagram illustrating the projection of partially overlapping images 114(1) through 114(6) onto a non-planar developable display surface 116 without correction. In FIG. 1C, images 114(1) through 114(6) appear as a set of distorted (i.e., warped) and disjointed (i.e., unaligned) images. Each image 114(1) through 114(6) appears distorted because of the display of a planar image onto a non-planar surface, and the set of images 114(1) through 114(6) appears disjointed because images 114 are not spatially aligned or otherwise displayed in a uniform way on display surface 116.

Without photometric correction, regions of overlap between images 114 may appear brighter than non-overlapping regions. In addition, variations between projectors 112 may result in variations in brightness and color gamut between projected images 114(1) through 114(6).

FIG. 1D is a schematic diagram illustrating the projection of images 114(1) through 114(6) onto non-planar developable display surface 116 with geometric and photometric correction. By applying geometric correction as described in Section II below, frame generator 108 unwarps, spatially aligns, and crops images 114(1) through 114(6) to minimize distortion in the display of images 114(1) through 114(6) on display surface 116. Frame generator 108 also spatially aligns images 114(1) through 114(6) as shown in FIG. 1D.

In addition, frame generator 108 may smooth any variations in brightness and color gamut between projected images 114(1) through 114(6) by applying photometric correction. For example, frame generator 108 may smooth variations in brightness in overlapping regions such as an overlapping region 150 between images 114(1) and 114(2), an overlapping region 152 between images 114(2), 114(3), and 114(4), and an overlapping region 154 between images 114(3), 114(4), 114(5), and 114(6). Frame generator 108 may smooth variations in brightness between images 114 displayed with different projectors 112.

Processing system 101 includes hardware, software, firmware, or a combination of these. In one embodiment, one or more components of processing system 101 are included in a computer, computer server, or other microprocessor-based system capable of performing a sequence of logic operations. In addition, processing can be distributed throughout the system with individual portions being implemented in separate system components, such as in a networked or multiple computing unit environment.

Image frame buffer 104 includes memory for storing one or more image frames of the streams of image frames 102. Thus, image frame buffer 104 constitutes a database of one or more image frames 102. Image frame buffers 113 also include memory for storing image frames 110. Although shown as separate frame buffers 113 in projectors 112 in the embodiment of FIG. 1, frame buffers 113 may be combined (e.g., into a single frame buffer) and may be external to projectors 112 (e.g., in processing system 101 or between processing system 101 and projectors 112) in other embodiments. Examples of image frame buffers 104 and 113 include non-volatile memory (e.g., a hard disk drive or other persistent storage device) and volatile memory (e.g., random access memory (RAM)).

It will be understood by a person of ordinary skill in the art that functions performed by processing system 101, including frame generator 108 and calibration unit 124, may be implemented in hardware, software, firmware, or any combination thereof. The implementation may be via one or more microprocessors, graphics processing units (GPUs), programmable logic devices, or state machines. In addition, functions of frame generator 108 and calibration unit 124 may be performed by separate processing systems in other embodiments. In such embodiments, geometric meshes 126 and photometric correction information 128 may be provided from calibration unit 124 to frame generator 108 using any suitable wired or wireless connection or any suitable intermediate storage device. Components of the present invention may reside in software on one or more computer-readable mediums. The term computer-readable medium as used herein is defined to include any kind of memory, volatile or non-volatile, such as floppy disks, hard disks, CD-ROMs, flash memory, read-only memory, and random access memory.

### II. Geometric Calibration and Correction of Displayed Images

In one embodiment, image display system 100 applies geometric correction to image frames 102 as part of the process of rendering image frames 110. As a result of the geometric correction, image display system 100 displays images 114 on display surface 116 using image frames 110 such that viewers may view images as being undistorted for all viewpoints of display surface 116.

Image display system 100 generates geometric meshes 126 as part of a geometric calibration process. Image display system 100 determines geometric meshes 126 using predetermined arrangements between points of fiducial marks 118. In one embodiment, image display system 100 determines geometric meshes 126 without knowing the shape or any dimensions of display surface 116 other than the predetermined arrangements of points of fiducial marks 118.

Frame generator 108 renders image frames 110 using respective geometric meshes 126 to unwarp, spatially align, and crop frames 102 into shapes that are suitable for display on display surface 116. Frame generator 108 renders image frames 110 to create precise pixel alignment between overlapping images 114 in the overlap regions (e.g., regions 150, 152, and 154 in FIG. 1D).

In the following description of generating and using geometric meshes 126, four types of 2D coordinate systems will be discussed. First, a projector domain coordinate system, Pᵢ, represents coordinates in frame buffer 113 of the ith projector 112. Second, a camera domain coordinate system, Cⱼ, represents coordinates in images 123 captured by the jth camera 122. Third, a screen domain coordinate system, S, represents coordinates in the plane formed by flattening display surface 116. Fourth, an image frame domain coordinate system, I, represent coordinates within image frames 102 to be rendered by frame generator 108.

Image display system 100 performs geometric correction on image frames 102 to conform images 114 from image frames 102 to display surface 116 without distortion. Accordingly, in the case of a single input image stream, the image frame domain coordinate system, I, of image frames 102 may be considered equivalent to the screen domain coordinate system, S, up to a scale in each of the two dimensions. By normalizing both coordinate systems to the range [0, 1], the image frame domain coordinate system, I, becomes identical to the screen domain coordinate system, S. Therefore, if mappings between the screen domain coordinate system, S, and each projector domain coordinate system, Pᵢ, are determined, then the mappings from each projector domain coordinate system, Pᵢ, to the image frame domain coordinate system, I, may be determined.

Let Pᵢ(\vec{s}) be a continuous-valued function that maps 2D screen coordinates \vec{s}=(sₓ,s_{y}) in S to coordinates \vec{p}=(p_{x,i},p_{y,i}) of the frame buffer 113 of the ith projector 112. Pᵢ is constructed as a composition of two coordinate mappings as shown in Equation 1:

\vec{p}ᵢ=Pᵢ(\vec{s})=C_{i,j}(Sⱼ(\vec{s})) (1)

where Sⱼ(\vec{s}) is a 2D mapping from display surface 116 to the image pixel locations of the jth observing camera 122, and C_{i,j}(\vec{c}ⱼ) is a 2D mapping from image pixel locations \vec{c}=(c_{x,j},c_{y,j}) of the jth observing camera 122 to the frame buffer 113 of the ith projector 112. If all Sⱼ and C_{i,j} are invertible mappings, the mappings from projector frame buffers to the flattened screen are constructed similarly from the inverses of the Sⱼ and C_{i,j} mappings, as shown in Equation 2:

\vec{s}=Pᵢ⁻¹(\vec{p}ᵢ)=Sⱼ⁻¹(C_{i,j}⁻¹(\vec{p}ᵢ)) (2)

Hence, all coordinate transforms required by the geometric correction can be derived from the Sⱼ and C_{i,j} mappings.

To handle a broad set of screen shapes, image display system 100 constructs generalized, non-parametric forms of these coordinate mappings. Specifically, for each mapping, image display system 100 uses a mesh-based coordinate transform derived from a set of point correspondences between the coordinate systems of interest.

Given a set of point correspondences between two 2D domains A and B, image display system 100 maps a point location \vec{a} in A to a coordinate \vec{b} in B as follows. Image display system 100 applies Delaunay triangulation to the points in A to create a first triangle mesh and then constructs the corresponding triangle mesh (according to the set of point correspondences) in B. To determine a point \vec{b} that corresponds to a point \vec{a}, image display system 100 finds the triangle in the triangle mesh in domain A that contains \vec{a}, or whose centroid is closest to it, and computes the barycentric coordinates of \vec{a} with respect to that triangle. Image display system 100 then selects the corresponding triangle from the triangle mesh in domain B and computes \vec{b} as the point having these same barycentric coordinates with respect to the triangle in B. Image display system 100 determines a point \vec{a} that corresponds to a point \vec{b} similarly.

The geometric meshes used to perform coordinate mappings have the advantage of allowing construction of coordinate mappings from point correspondences where the points in either domain may be in any arrangement other than collinear. This in turn allows greater flexibility in the calibration methods used for measuring the locations of the points involved in the point correspondences. For example, the points on display surface 116 may be located entirely outside the area used to display projected images 114, so that these points do not interfere with displayed imagery, and may be left in place while the display is in use. Other non-parametric representations of coordinate mappings, such as 2D lookup tables, are generally constructed from 2D arrays of point correspondences. In many instances it is not convenient to use 2D arrays of points. For example, a 2D array of points on display surface 116 may interfere with displayed imagery 114, so that these points may need to be removed after calibration and prior to use of the display. Also, meshes may more easily allow for spatial variation in the fineness of the coordinate mappings, so that more point correspondences and triangles may be used in display surface areas that require finer calibration. Finer mesh detail may be localized independently to specific 2D regions within meshes by using more point correspondences in these regions, whereas increased fineness in the rows or columns of a 2D lookup table generally affects a coordinate mapping across the entire width or height extent of the mapping. In many instances, a mesh-based representation of a coordinate mapping may also be more compact, and hence require less storage and less computation during the mapping process, than a similarly accurate coordinate mapping stored in another non-parametric form such as a lookup table.

To determine the correct projector frame buffer contents needed to render the input image like wallpaper on the screen, image display system 100 applies Equation 2 to determine the screen location \vec{s} that each projector pixel \vec{p} lights up. If \vec{s} is normalized to [0, 1] in both dimensions, then this is also the coordinate for the input image pixel whose color should be placed in \vec{p}, since wallpapering the screen effectively equates the 2D flattened screen coordinate systems S with the image coordinate system I. For each projector 112, image display system 100 uses Equation 2 to compute the image coordinates corresponding to each location on a sparsely sampled rectangular grid (e.g., a 20×20 grid) in the screen coordinate space. Graphics hardware fills the projector frame buffer via texture mapping image interpolation. Hence, the final output of the geometric calibration in one embodiment is one triangle mesh 126 per projector 112, computed on the rectangular grid.

Because the method just described includes a dense mapping to the physical screen coordinate system, it corrects for image distortion caused not only by screen curvature, but also due to the projector lenses. Furthermore, the lens distortion of the observing camera(s) 122, inserted by interposing their coordinate systems between those of the projectors and the screen, does not need to be calibrated and corrected. In fact, the method allows use of cameras 122 with extremely wide angle lenses, without any need for camera image undistortion. Because of this, image display system 100 may be calibrated with a single, wide-angle camera 122. This approach can even be used to calibrate full 360 degree displays, by placing a conical mirror in front of the camera lens to obtain a panoramic field-of-view.

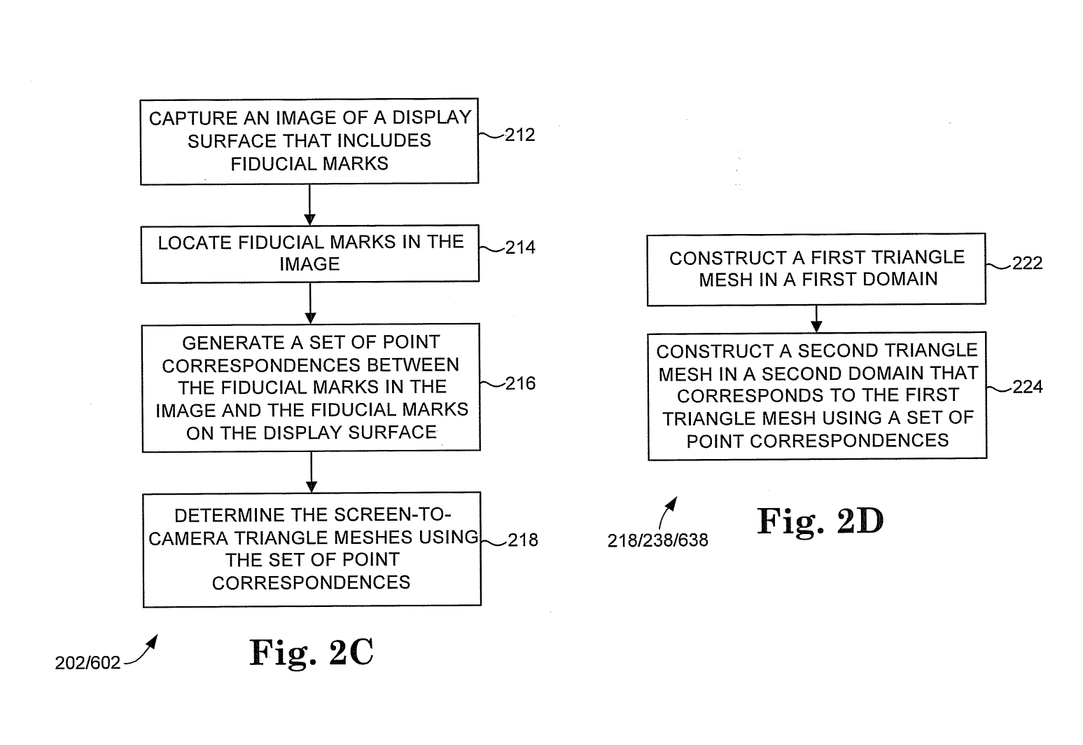

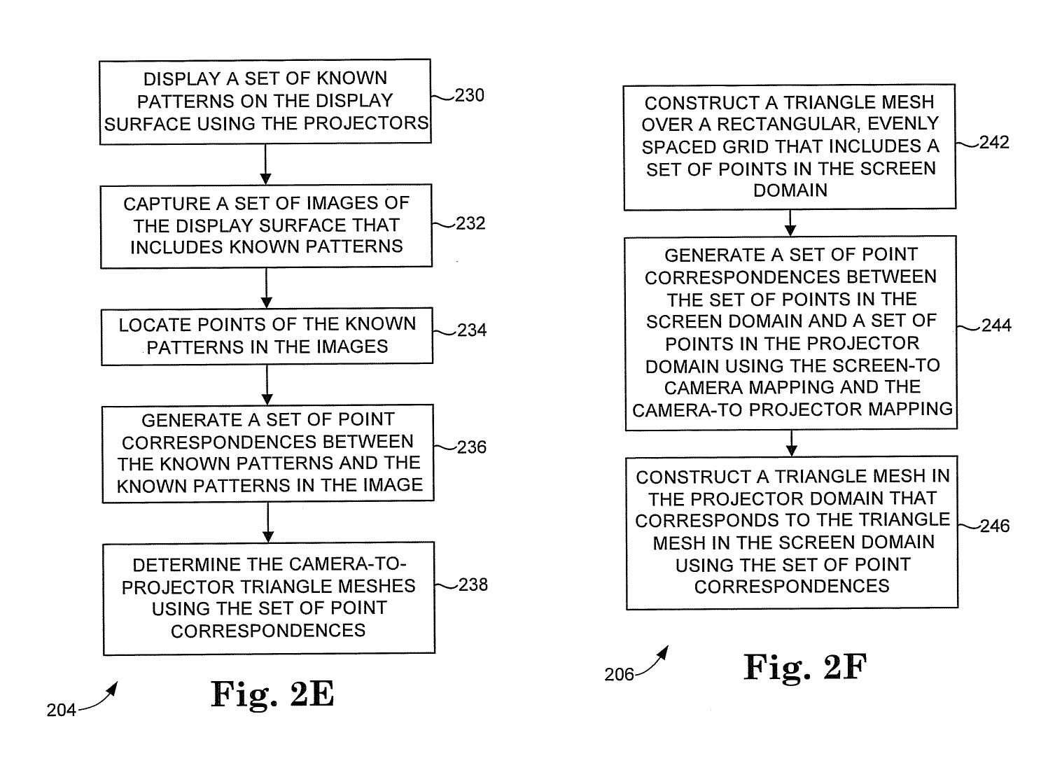

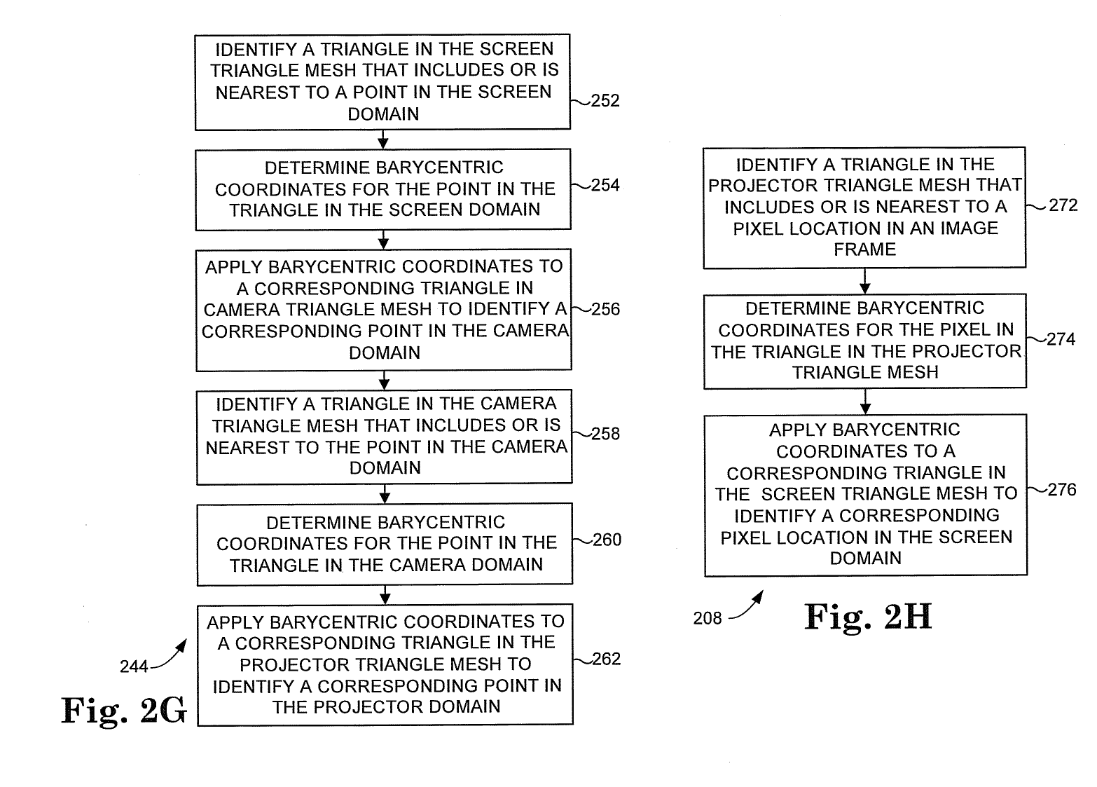

Methods of performing geometric correction will now be described in additional detail with reference to the embodiments of FIGS. 2A-2H. FIGS. 2A-2H are flow charts illustrating methods for geometric correction. FIG. 2A illustrates the overall calibration process to generate geometric meshes 126 according to one embodiment, and FIG. 2B illustrates the rendering process using geometric meshes 126 to perform geometric correction on image frames 102 according to one embodiment. FIGS. 2C through 2H illustrate additional details of the functions of the blocks shown in FIGS. 2A and 2B. The embodiments of FIGS. 2A-2H will be described with reference to image display system 100 as illustrated in FIG. 1.

The methods of FIGS. 2A-2H will be described for an embodiment of image display system 100 that includes a single camera 122. In embodiments that include multiple cameras 122, then methods of FIGS. 2A-2H may be generalized for multiple cameras 122 using Equations 1 and 2 above. With multiple cameras 122, image display system 100 may also align meshes from multiple cameras 122 onto a single mesh in the camera domain. When fields-of-view of multiple cameras overlap the same screen or projector region, mesh-based coordinate mapping results from different cameras 122 may be combined in a weighted average, with the weights optionally being determined by the distance of the location from the edges of the camera fields-of-view. In addition, image display system 100 registers the different camera coordinate systems using projector or screen points from their overlap regions, and/or using any of the many methods for multi-camera geometric calibration known in the art.

In the embodiments described below, geometric meshes 126 will be described as triangle meshes where each triangle mesh forms a set of triangles, and where each triangle is described with a set of three coordinate locations (i.e., vertices). Each triangle in a triangle mesh corresponds to another triangle (i.e., a set of three coordinate locations or vertices) in another triangle mesh from another domain. Accordingly, corresponding triangles in two domains may be represented by six coordinate locations—three coordinate locations in the first domain and three coordinate locations in the second domain.

In other embodiments, geometric meshes 126 may be polygonal meshes with polygons with z sides, where z is greater than or equal to four. In these embodiments, corresponding polygons in two domains may be represented by 2z ordered coordinate locations—z ordered coordinate locations in the first domain and z ordered coordinate locations in the second domain.

In FIG. 2A, calibration unit 124 generates screen-to-camera triangle meshes as indicated in a block 202. In particular, calibration unit 124 generates a triangle mesh in the screen domain and a corresponding triangle mesh in the camera domain. Calibration unit 124 generates these triangle meshes using knowledge of a predetermined arrangement of fiducial marks 118, and an image 123 captured by camera 122 that includes these fiducial marks 118 on display surface 116.

Calibration unit 124 also generates camera-to-projector triangle meshes for each projector 112 as indicated in a block 204. In particular, calibration unit 124 generates a second triangle mesh in the camera domain and a corresponding triangle mesh in the projector domain for each projector 112. Calibration unit 124 generates these triangle meshes from known pattern sequences displayed by projectors 112 and a set of images 123 captured by camera 122 viewing display surface 116 while these known pattern sequences are projected by projectors 112.

Calibration unit 124 generates a screen-to-projector triangle mesh, also referred to as geometric mesh 126, for each projector 112 as indicated in a block 206. Calibration unit 124 generates geometric meshes 126 such that each geometric mesh 126 includes a set of points that are associated with a respective projector 112. Calibration unit 124 identifies the set of points for each projector 112 using the screen-to-camera triangle meshes and the camera-to-projector triangle meshes as described in additional detail below with reference to FIGS. 2F and 2G.

Referring to FIG. 2B, frame generator 108 renders frames 110 for each projector 112 using the respective geometric mesh 126 as indicated in a block 208. Frame generator 108 provides respective frames 110 to respective frame buffers 113 in respective projectors 112. Projectors 112 project respective frames 110 onto display surface 116 in partially overlapping positions as indicated in a block 210. Because each geometric mesh 126 defines a mapping between display surface 116 and a frame buffer 113 of a respective projector 112, frame generator 108 uses geometric meshes 126 to warp frames 102 into frames 110 such that frames 110 appear spatially aligned and without distortion when projected by projectors 112 as images 114 in partially overlapping positions on display surface 116. Frame generator 108 interpolates the pixel values for frames 110 using the geometric meshes 126 as described in additional detail below with reference to FIG. 2H.

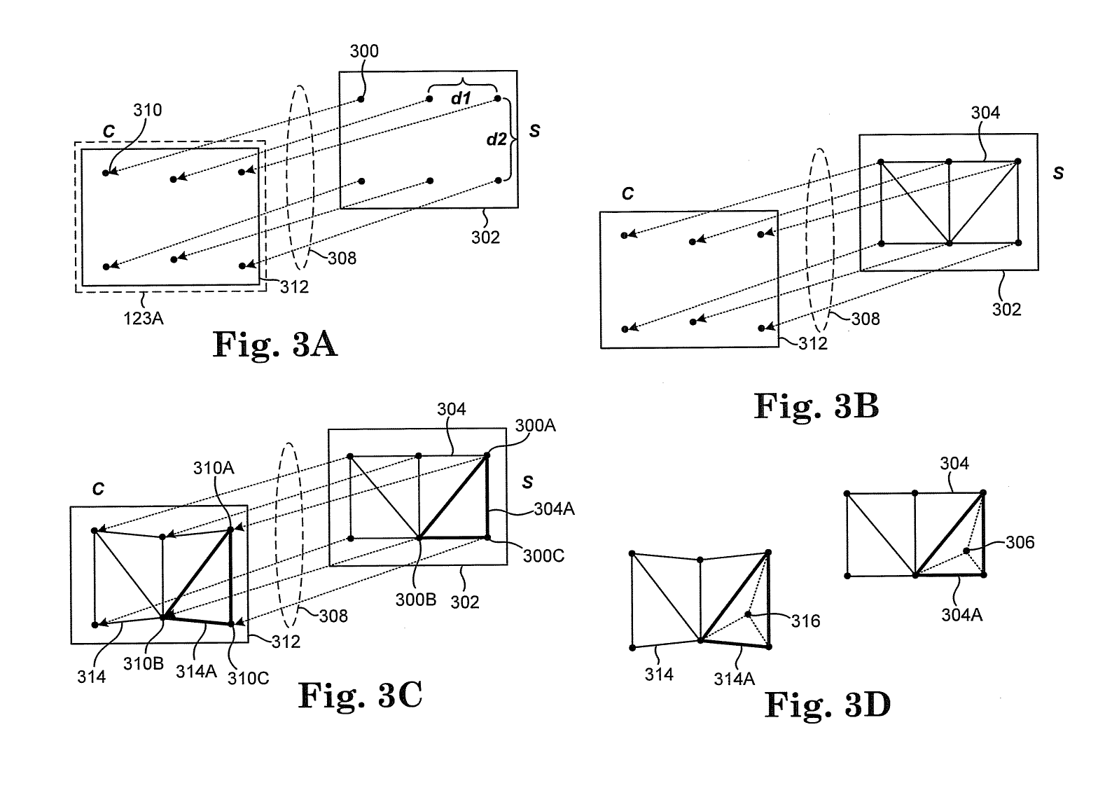

FIG. 2C illustrates a method for performing the function of block 202 of FIG. 2A. Namely, the method of FIG. 2C illustrates one embodiment of generating screen-to-camera triangle meshes. The method of FIG. 2C will be described with reference to FIGS. 3A-3D.

In FIG. 2C, camera 122 captures an image 123A (shown in FIG. 3A) of display surface 116 that includes fiducial marks 118 as indicated in a block 212. Fiducial marks 118 include points identifiable in image 123A by calibration unit 124 where the arrangement of the points is predetermined. For example, fiducial marks 118 may form a black and white checkerboard pattern where the distances between all adjacent corners are the same linear distance.

Calibration unit 124 locates fiducial marks 118 in image 123A as indicated in a block 214. Calibration unit 124 locates fiducial marks 118 to identify where points are located according to a predetermined arrangement on display screen 116. For example, where fiducial marks 118 form a black and white checkerboard pattern as in the example shown in FIG. 1D, calibration unit 124 may detect the points using a standard corner detector along with the following algorithm such that the detected corners form the points located according to a predetermined arrangement on display screen 116.

In one embodiment, calibration unit 124 assumes the center of image 123A is inside the region of display surface 116 to be used for display, where this region is at least partially bounded by strips of fiducial marks 118, and where the region contains no fiducial marks 118 in its interior. The boundary of the region along which fiducial marks 118 appear may coincide with the boundary of display surface 116, or may fall entirely or partially in the interior of display surface 116. FIG. 1C shows example strips 118A and 118B located along the top and bottom borders of display surface 116. The strips contain checkerboard patterns, with all squares having equal size. The physical size of these squares is predetermined, and therefore the physical distances along the screen surface between successive corners on the interior horizontal line within each strip is known.

Calibration unit 124 begins searching from the center of camera image 123A going upward for the lowest detected corner. Referring back to fiducial marker strip 118A in FIG. 1D, calibration unit 124 may assume that this lowest detected corner (i.e., the first fiducial mark) is on the bottom row of fiducial marker strip 118A. Calibration unit 124 finds the next lowest corner searching upward (e.g., an interior corner of the checkerboard pattern) and saves the vertical distance from the first corner to the next lowest corner as a vertical pattern step.

Calibration unit 124 searches left from the interior corner for successive corners along fiducial marker strip 118A at the step distance (estimating the horizontal pattern step to be equal to the vertical pattern step), plus or minus a tolerance, until no more corners are detected in the expected locations. In traversing the image of the strip of fiducial marker strip 118A, calibration unit 124 predicts the location of the next corner in sequence by extrapolating using the pattern step to estimate the 2D displacement in camera image 123A from the previous corner to the next corner. By doing so, calibration unit 124 may follow accurately the smooth curve of the upper strip of fiducial marks 118 which appears in image 123A.

Calibration unit 124 then returns to the first fiducial location and continues the search to the right in a manner analogous to that described for searching to the left. Calibration unit 124 subsequently returns to the center of camera image 123A, and searches downward to locate a first corner in fiducial marks 118B. This corner is assumed to be on the top row of fiducial marker strip 118B. The procedure used for finding all corners in upper fiducial strip 118A is then carried out in an analogous way for the lower strip, this time using the corners in the row of fiducial strip 118B below the row containing the first detected corner. Searches to the left and right are carried out as before, and locations of all corners in the middle row of fiducial strip 118B are stored.

In FIG. 3A, points 300 represent the points in a screen domain (S) 302 that are separated by an example predetermined arrangement—with a predetermined separation distance (d1) in the horizontal direction and a predetermined separation distance (d2) in the vertical direction on display screen 116. Points 310 represent the points in a camera domain (C) 312 that are identified in image 123A by calibration unit 124 as just described (e.g., as interior corner locations of a black and white checkerboard pattern). In other embodiments, points 300 may be arranged with other known geometry, distances, and/or other scaling information between points 300.

Referring to FIGS. 2C and 3A, calibration unit 124 generates a set of point correspondences 308 between fiducial marks 118 detected in image 123A and fiducial marks 118 on display surface 116 as indicated in a block 216. The set of point correspondences 308 are represented by arrows that identify corresponding points in screen domain 302 and camera domain 312. These correspondences are generated by matching detected fiducial marks in camera image 123A with the predetermined arrangement of fiducial marks 118 on display surface 116. The algorithm described above for fiducial strips 118A and 118B describes one method for making these correspondences for a particular arrangement of fiducial marks 118, but other algorithms can be used for other arrangements of fiducial marks.

Calibration unit 124 determines screen-to-camera triangle meshes using the set of correspondences 308 as indicated in a block 218. The screen-to-camera triangle meshes are used to map screen domain (S) 302 to camera domain (C) 312 and vice versa. Calibration unit 124 determines screen-to-camera triangle meshes using the method illustrated in FIG. 2D. FIG. 2D illustrates a method for generating a triangle mesh in each of two domains.

Referring to FIG. 2D and FIG. 3B, calibration unit 124 constructs a first triangle mesh in a first domain as indicated in a block 222. In the example of FIG. 3B, calibration unit 124 constructs a triangle mesh 304 in screen domain 302 by connecting points 300. Calibration unit 124 constructs triangle mesh 304 using Delaunay triangulation or any other suitable triangulation algorithm.

Calibration unit 124 constructs a second triangle mesh in a second domain that corresponds to the first triangle mesh using a set of point correspondences as indicated in a block 224. Referring to FIG. 3C, calibration unit 124 constructs a triangle mesh 314 in camera domain 312 by connecting points 310 in the same way that corresponding points 300, according to point correspondences 308, are connected in screen domain 302.

Calibration unit 124 uses the set of point correspondences 308 to ensure that triangles in triangle mesh 314 correspond to triangles in triangle mesh 304. For example, points 300A, 300B, and 300C correspond to points 310A, 310B, and 310C as shown by the set of point correspondences 308. Accordingly, because calibration unit 124 formed a triangle 304A in triangle mesh 304 using points 300A, 300B, and 300C, calibration unit 124 also forms a triangle 314A in triangle mesh 314 using points 310A, 310B, and 310C. Triangle 314A therefore corresponds to triangle 304A.

In other embodiments, calibration unit 124 may first construct triangle mesh 314 in camera domain 312 (e.g. by Delaunay triangulation) and then construct triangle mesh 304 in screen domain 302 using the set of point correspondences 308.

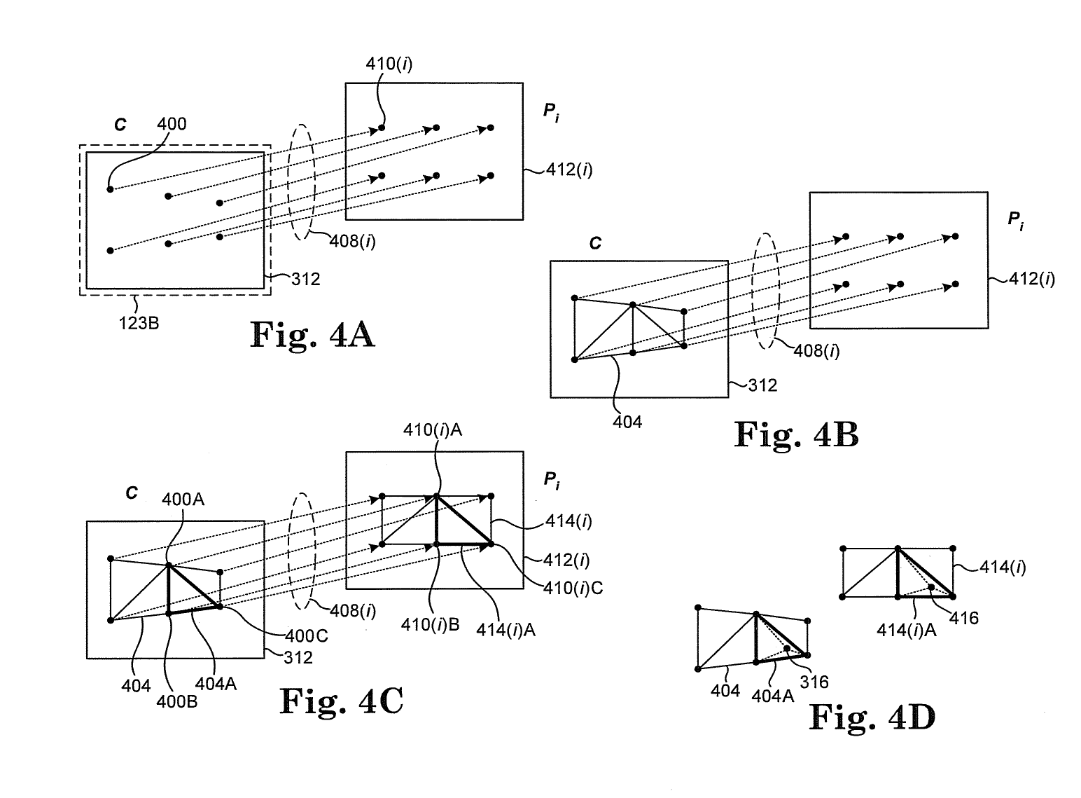

FIG. 2E illustrates a method for performing the function of block 204 of FIG. 2A. Namely, the method of FIG. 2E illustrates one embodiment of generating camera-to-projector triangle meshes. The method of FIG. 2E will be described with reference to FIGS. 4A-4D. The method of FIG. 2E is performed for each projector 112 to generate camera-to-projector triangle meshes for each projector 112.

In FIG. 2E, calibration unit 124 causes a projector 112 to display a set of known pattern sequences on display surface 116 as indicated in a block 230. Calibration unit 124 provides a series of frames 110 with known patterns to frame buffer 113 in projector 112 by way of frame generator 108. Projector 112 displays the series of known patterns.

Camera 122 captures a set of images 123B (shown in FIG. 4A) of display surface 116 while the known patterns are being projected onto display surface 116 by projector 112 as indicated in a block 232. The known patterns may be any suitable patterns that allow calibration unit 124 to identify points in the patterns using images 123B captured by camera 122. For example, the known patterns may be a sequence of horizontal and vertical black-and-white bar patterns.

Calibration unit 124 locates points of the known patterns in images 123B as indicated in a block 234. In FIG. 4A, points 400 represent the points in camera domain (C) 312 located by calibration unit 124. In one embodiment, calibration unit 124 locates the points by projecting a known series of known black-and-white patterns onto display surface 116, and then correlating sequences of black and white pixel observations in images 123B of these known patterns with the sequences of black and white values at locations within the projected pattern coordinate space. For each camera image 123B of a known pattern, pixels are classified as corresponding to a black projected pattern element, a white projected pattern element, or being outside the coverage area of the projector. Each camera pixel location within the coverage area of the projector is then assigned a black/white bit-sequence summarizing the sequence of observations found while the known patterns were displayed in sequence. Calibration unit 124 uses the bit sequences as position codes for the camera pixels. A camera location image may be formed to display the position codes for each camera pixel. The camera location image may be divided into code set regions, each region containing camera pixel locations all having an identical associated black/white bit sequence. The size and number of code set regions in the camera location image depends upon the number and fineness of the bar patterns. A similar projector location image may be formed by displaying the black/white bit sequences at each projector pixel location as the known patterns were being displayed in a known sequence. The projector location image may also be divided into position code set regions, each region containing projector pixels all having an identical associated black/white bit sequence. A correspondence between code set regions in the camera and projector location images is made by matching the black/white bit sequence position codes of respective regions in the two images. Calibration unit 124 computes the centers-of-mass of the detected code set regions in the camera location image as the points to be associated with the centers-of-mass of the corresponding code set regions in the projector location image of projector 112.

Referring to FIGS. 2E and 4A, calibration unit 124 generates a set of point correspondences 408(i) between the known patterns (in the coordinate space of projector 112) and camera images 123B of these known patterns as indicated in a block 236. Points 410(i) represent the ith points (where i is between 1 and N) in an ith projector domain (Pᵢ) 412(i) that are identified in image 123B by calibration unit 124. The ith set of point correspondences 408(i) are represented by arrows that identify corresponding points in camera domain 312 and projector domain 412(i).

In one embodiment, calibration unit 124 associates the centers-of-mass of the detected position code sets in the camera location image (i.e., points 400) with the centers-of-mass of the corresponding position code sets (i.e., points 410(i) of the known patterns) provided to frame-buffer 113 of projector 112 to generate the set of point correspondences 408(i).

Calibration unit 124 determines camera-to-projector triangle meshes using the set of correspondences 408(i) as indicated in a block 238. The camera-to-projector triangle meshes are used to map camera domain (C) 312 to projector domain (Pᵢ) 412(i) and vice versa. Calibration unit 124 determines camera-to-projector triangle meshes using the method illustrated in FIG. 2D.

Referring to FIG. 2D and FIG. 4B, calibration unit 124 constructs a first triangle mesh in a first domain as indicated in block 222. In the example of FIG. 4B, calibration unit 124 constructs a triangle mesh 404 in camera domain 312 by connecting points 400. Calibration unit 124 constructs triangle mesh 404 using Delaunay triangulation or any other suitable triangulation algorithm.

Calibration unit 124 constructs a second triangle mesh in a second domain that corresponds to the first triangle mesh using a set of point correspondences as indicated in block 224. Referring to FIG. 4C, calibration unit 124 constructs a triangle mesh 414(i) in projector domain 412(i) by connecting points 410(i) using the set of point correspondences 408(i) in the same way that corresponding points 400, according to point correspondences 408(i), are connected in camera domain 312.

Calibration unit 124 uses the set of point correspondences 408(i) to ensure that triangles in triangle mesh 414(i) correspond to triangles in triangle mesh 404. For example, points 400A, 400B, and 400C correspond to points 410(i)A, 410(i)B, and 410(i)C as shown by the set of point correspondences 408(i). Accordingly, because calibration unit 124 formed a triangle 404A in triangle mesh 404 using points 400A, 400B, and 400C, calibration unit 124 also forms a triangle 414(i)A in triangle mesh 414(i) using points 410(i)A, 410(i)B, and 410(i)C. Triangle 414(i)A therefore corresponds to triangle 404A.

In other embodiments, calibration unit 124 may first construct triangle mesh 414(i) in projector domain 412(i) and then construct triangle mesh 404 in camera domain 312 using the set of point correspondences 408(i).

Referring back to block 206 of FIG. 2A, calibration unit 124 generates a geometric mesh 126 for each projector 112 using the screen-to-camera meshes (block 202 and FIG. 2C) and camera-to-projector meshes for each projector 112 (block 204 and FIG. 2E). Each geometric mesh 126 maps screen domain (S) 302 to a projector domain (Pᵢ) 412 and vice versa.

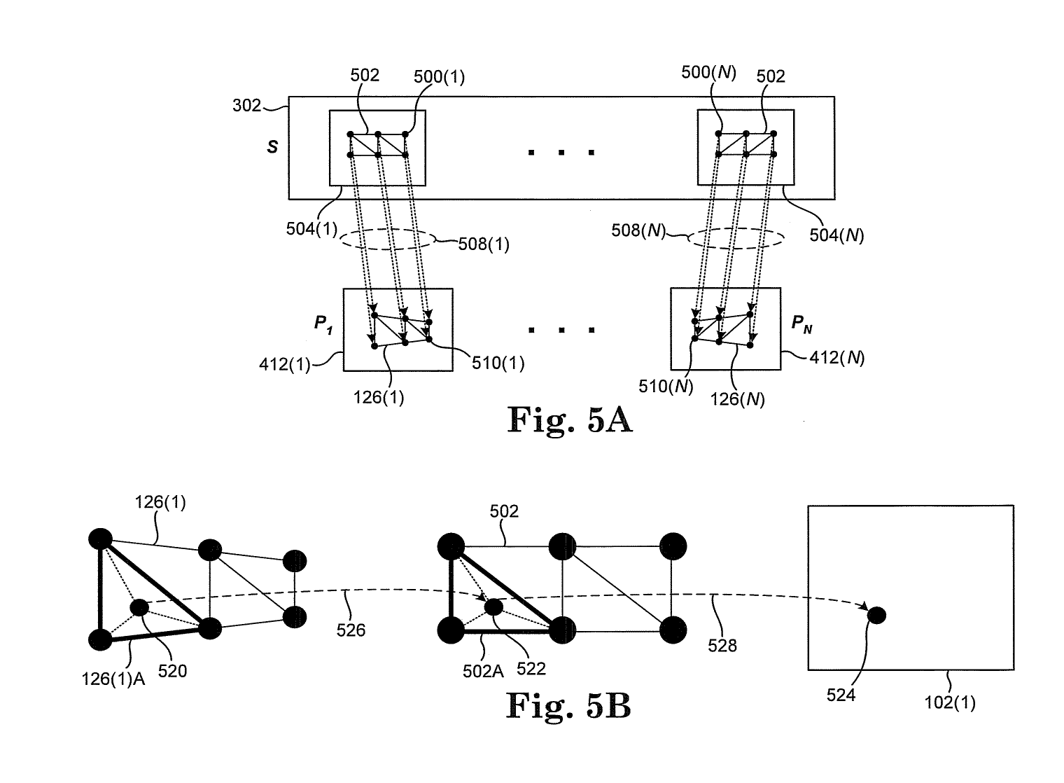

FIG. 2F illustrates a method for performing the function of block 206 of FIG. 2A. Namely, the method of FIG. 2F illustrates one embodiment of generating a geometric mesh 126 that maps the screen domain to a projector domain of a projector 112. The method of FIG. 2F will be described with reference to the example of FIG. 5A. The method of FIG. 2F is performed for each projector 112 to generate geometric meshes 126(1) through 126(N) for respective projectors 112(1) through 112(N).

The method of FIG. 2F will be described below for generating geometric mesh 126(1). Geometric meshes 126(2) through 126(N) are generated similarly.

Referring to FIGS. 2F and 5A, calibration unit 124 constructs a triangle mesh 502 over a rectangular, evenly spaced grid that includes a set of points 500 in screen domain 302 as indicated in a block 242. In other embodiments, triangle mesh 502 may be constructed over an arrangements of points 500 other than rectangular, evenly-spaced grids. The set of points 500 occur at least partially in a region 504(1) of screen domain 302 where projector 112(1) is configured to display image 114(1). Delaunay triangulation or other suitable triangulation methods are used to construct a triangle mesh from the set of points 500(1).

Calibration unit 124 generates a set of point correspondences 508(1) between the set of points 500 in screen domain 302 and a set of points 510(1) in projector domain 412(1) using the screen-to-camera meshes and the camera-to-projector meshes for projector 112(1) as indicated in a block 244.

FIG. 2G illustrates one embodiment of a method for generating a point correspondence in the set of point correspondences 508(1) in block 244 of FIG. 2F. The method of FIG. 2G will be described with reference to FIGS. 3D and 4D.

In FIG. 2G, calibration unit 124 identifies a triangle in the screen triangle mesh (determined in block 218 of FIG. 2C) that includes or is nearest to a point in the screen domain as indicated in a block 252. In FIG. 3D, for example, calibration unit 124 identifies triangle 304A in triangle mesh 304 that includes a point 306 in screen domain 302.

Calibration unit 124 determines barycentric coordinates for the point in the triangle in the screen domain as indicated in a block 254. In the example of FIG. 3D, calibration unit 124 determines barycentric coordinates for point 306 in triangle 304A, as represented by the dotted lines that connect point 306 to the vertices of triangle 304A, in screen domain 302.

Calibration unit 124 applies the barycentric coordinates to a corresponding triangle in the camera triangle mesh (determined in block 218 of FIG. 2C) to identify a point in the camera domain that corresponds to the point in the screen domain as indicated in a block 256. In the example of FIG. 3D, calibration unit 124 applies the barycentric coordinates to a corresponding triangle 314A in triangle mesh 314 to identify a point 316 in camera domain 312 that corresponds to point 306 in screen domain 302.

Calibration unit 124 identifies a triangle in the camera triangle mesh (as determined in block 238 of FIG. 2E) that includes or is nearest to the point in the camera domain as indicated in a block 258. In FIG. 4D, for example, calibration unit 124 identifies triangle 404A in triangle mesh 404 that includes point 316 in camera domain 312.

Calibration unit 124 determines barycentric coordinates for the point in the triangle in the camera domain as indicated in a block 260. In the example of FIG. 4D, calibration unit 124 determines barycentric coordinates for point 316 in triangle 404A, as represented by the dotted lines that connect point 316 to the vertices of triangle 404A, in camera domain 312.

Calibration unit 124 applies the barycentric coordinates to a corresponding triangle in the projector triangle mesh (as determined in block 238 of FIG. 2E) to identify a point in the projector domain that corresponds to the point in the camera domain as indicated in a block 262. In the example of FIG. 4D, calibration unit 124 applies the barycentric coordinates to a corresponding triangle 414(i)A in triangle mesh 414(i) to identify a point 416 in projector domain 412(i) that corresponds to point 316 in screen domain 312.

By performing the method of FIG. 2G, calibration unit 124 generates a point correspondence in the set of point correspondences 508(1). In the example of FIGS. 3D and 4D, calibration unit 124 generates a point correspondence between point 306 in screen domain 302 and point 416 in projector domain 412(i) using screen-to-camera meshes 304 and 314 and camera-to-projector meshes 404 and 414(i). The method of FIG. 2G is repeated for each selected point of triangle mesh 502 to generate the remaining point correspondences in the set of point correspondences 508(1).

Referring back to FIGS. 2F and 5A, calibration unit 124 constructs a geometric triangle mesh 126(1) in projector domain 412(1) that corresponds to triangle mesh 502 in screen domain 302 using the set of point correspondences 508(1) as indicated in a block 246. Calibration unit 124 constructs geometric triangle mesh 126(1) in projector domain 412(1) by connecting points 510(1) according to the set of point correspondences 508(1). Calibration unit 124 uses the set of point correspondences 508(1) to ensure that triangles in triangle mesh 126(1) correspond to triangles in triangle mesh 502.

In other embodiments, calibration unit 124 may first construct triangle mesh 126(1) in projector domain 412(1), using Delaunay triangulation or other suitable triangulation methods, and then construct triangle mesh 502 in screen domain 312 using the set of point correspondences 508(1).

Referring back to block 208 of FIG. 2B, frame generator 108 renders frames 110 using respective geometric meshes 126. FIG. 2H illustrates a method for mapping locations in frames 110 to locations in projector frame buffers 113 to allow the function of block 208 to be performed. The method of FIG. 2H is performed by frame generator 108 for each pixel in each frame 110 using a respective geometric mesh 126 to determine the pixel colors of frame 110. The method of FIG. 2H will now be described as being performed by frame generator 108 for a frame 110(1). Frame generator 108 performs the method of FIG. 2H for frames 110(2) through 110(N) similarly. The method of FIG. 2H will be described with reference to an example in FIG. 5B.

Referring to FIGS. 2H and 5B, frame generator 108 identifies a triangle in a respective projector triangle mesh that includes or is nearest to a pixel in frame 110(1) as indicated in a block 272. The projector triangle mesh, in the context of rendering, refers to a geometric mesh 126(1) from block 246 of FIG. 2F that was constructed to correspond to screen triangle mesh 502. In FIG. 5B, for example, frame generator 108 identifies triangle 126(1)A in geometric mesh 126(1) that includes point 520. A coordinate correspondence is also made between screen domain 302 and the image domain I of an image frame 102 to be displayed. The correspondence may include scaling, rotation, and translation, so that a rectangular portion of image frame 102 may correspond to any rectangular region of the 2D plane made by flattening display surface 116. Because of this coordinate correspondence between image domain I and screen domain 302, triangle mesh 502 corresponds to the image domain, I, of frame 102 as described in additional detail above.

Frame generator 108 determines barycentric coordinates for a pixel location in frame buffer 113(1) in the triangle of projector triangle mesh 126(1) as indicated in a block 274. In the example of FIG. 5B, frame generator 108 determines barycentric coordinates for point 520 in triangle 126(1)A, as represented by the dotted lines that connect point 520 to the vertices of triangle 126(1)A.

Frame generator 108 applies the barycentric coordinates to a corresponding triangle in screen triangle mesh 502 to identify a screen location, and hence a corresponding pixel location in image frame 102, as indicated in a block 276. In the example of FIG. 5B, frame generator 108 applies the barycentric coordinates to a corresponding triangle 502A in triangle mesh 502 to identify a point 522 that corresponds to point 520 as indicated by a dashed arrow 526. Point 522 corresponds to a point 524 in image frame 102(1) as indicated by a dashed arrow 528. The color at this pixel location in frame buffer 113(1) is filled in with the color of the image data at the image domain I location corresponding to the screen location in screen triangle mesh 502.

Interpolation of image color between pixel locations in image domain I may be used as part of this process, if the location determined in image frame 102 is non-integral. This technique may be implemented efficiently by using the texture mapping capabilities of many standard personal computer graphics hardware cards. In other embodiments, alternative techniques for warping frames 102 to correct for geometric distortion using geometric meshes 126 may be used, including forward mapping methods that map from coordinates of image frames 102 to pixel location in projector frame buffers 113 (via screen-to-projector mappings) to select the pixel colors of image frames 102 to be drawn into projector frame buffers 113.

By mapping frames 102 to projector frame buffers 113, frame generator 108 may warp frames 102 into frames 110 to geometrically correct the display of images 114.

Although the above methods contemplate the use of an embodiment of display system 100 with multiple projectors 112, the above methods may also be applied to an embodiment with a single projector 112.

In addition, the above methods may be used to perform geometric correction on non-developable display surfaces.

### III. Chromatic Aberration Correction of Displayed Images

As described above in section II, image display system 100 applies geometric correction to image frames 102 as part of the process of rendering image frames 110. Image display system 100 generates geometric meshes 126 as part of a geometric calibration process. In one embodiment, as described in section II, calibration unit 124 generates one geometric mesh 126 for each of the projectors 112. Thus, if there are N projectors 112, there are N geometric meshes 126 in this embodiment. In one form of this embodiment, the geometric mesh 126 for each projector 112 is a color-independent mesh that is applied uniformly to the primary color channels (e.g., red, green, and blue color channels) of the projector 112, and corrects for achromatic aberrations or distortions.

In another embodiment, display system 100 is configured to perform dynamic digital correction of chromatic aberrations. Lenses typically have dispersive effects and act like prisms. When different wavelengths of light pass through such lenses, the different wavelengths form images at different points in the image plane. All of the different color components of a point in a source image do not converge to the exact same point in the projected image. These effects are referred to herein as chromatic aberrations.

In one embodiment, calibration unit 124 generates a plurality (e.g., three) of color-dependent geometric meshes 126 for each of the projectors 112, with each such mesh 126 corresponding to a different primary color (e.g., red, green, and blue) or set of wavelengths. In one form of this embodiment, if there are N projectors 112, there are 3N color-dependent geometric meshes 126. The three color-dependent geometric meshes 126 for each projector 112 in this embodiment correct for chromatic aberrations or distortions. In one embodiment, the three color-dependent geometric meshes 126 for each projector 112 include a first geometric mesh 126 for the red color band or channel, a second geometric mesh 126 for the green color band or channel, and a third geometric mesh 126 for the blue color band or channel.

Frame generator 108 renders image frames 110 using the color-dependent geometric meshes 126. In one embodiment, the first geometric mesh 126 for a given projector 112 is applied to the red color channel of a given image frame 102, the second geometric mesh 126 for the projector 112 is applied to the green color channel of the image frame 102, and the third geometric mesh 126 for the projector 112 is applied to the blue color channel of the image frame 102. In one embodiment, display system 100 dynamically applies chromatic aberration correction at real-time video-rates to images streaming to the multiple projectors 112.

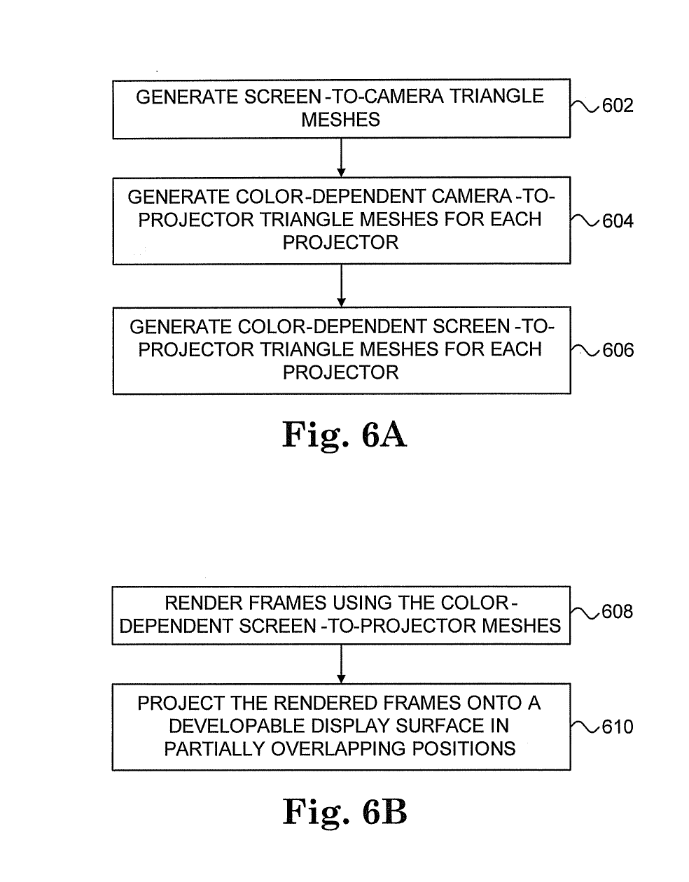

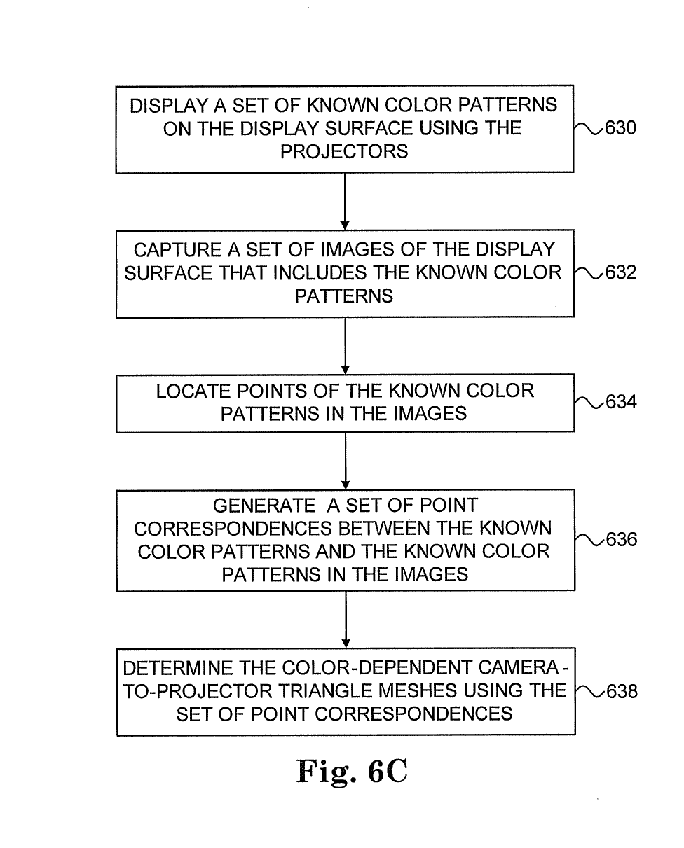

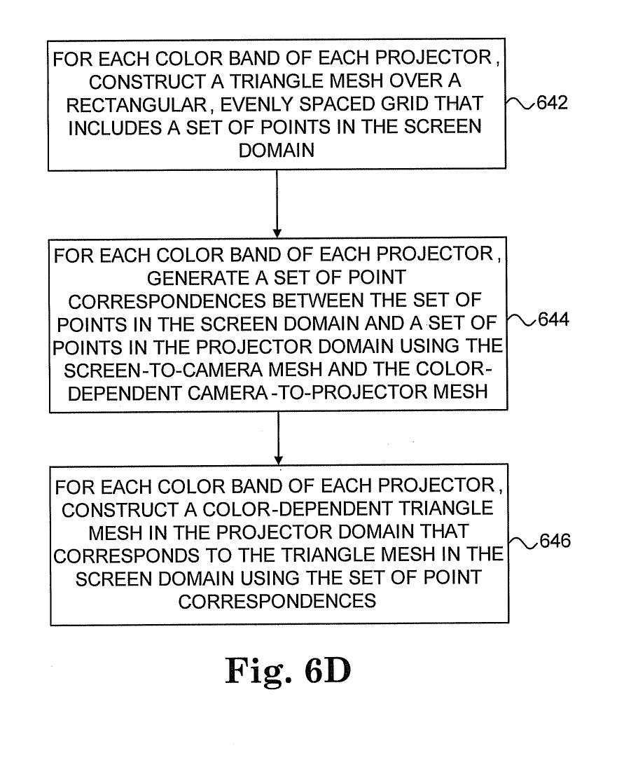

Methods of performing chromatic aberration correction will now be described in additional detail with reference to the embodiments of FIGS. 6A-6D. FIGS. 6A-6D are flow charts illustrating methods for chromatic aberration correction. FIG. 6A illustrates the overall calibration process to generate color-dependent geometric meshes 126 according to one embodiment, and FIG. 6B illustrates the rendering process using the color-dependent geometric meshes 126 to perform chromatic aberration correction on image frames 102 according to one embodiment. FIGS. 6C and 6D illustrate additional details of the functions of the blocks shown in FIGS. 6A and 6B. The embodiments of FIGS. 6A-6D will be described with reference to image display system 100 as illustrated in FIG. 1.

In FIG. 6A, calibration unit 124 generates screen-to-camera triangle meshes as indicated in a block 602. In particular, calibration unit 124 generates a triangle mesh in the screen domain and a corresponding triangle mesh in the camera domain. Calibration unit 124 generates these triangle meshes using knowledge of a predetermined arrangement of fiducial marks 118, and an image 123 captured by camera 122 that includes these fiducial marks 118 on display surface 116.

Calibration unit 124 also generates color-dependent camera-to-projector triangle meshes for each projector 112 as indicated in a block 604. In particular, for each projector 112, calibration unit 124 generates a second triangle mesh in the camera domain and three triangle meshes in the projector domain. The three triangle meshes in the projector domain according to one embodiment include a first triangle mesh for the red color band, a second triangle mesh for the green color band, and a third triangle mesh for the blue color band. Calibration unit 124 generates these triangle meshes from known color pattern sequences displayed by projectors 112 and a set of images 123 captured by camera 122 viewing display surface 116 while these known color pattern sequences are projected by projectors 112.

Calibration unit 124 generates color-dependent screen-to-projector triangle meshes, also referred to as color-dependent geometric meshes 126, for each projector 112, as indicated in a block 606. Calibration unit 124 generates color-dependent geometric meshes 126 such that each color-dependent geometric mesh 126 includes a set of points that are associated with a color band of a respective projector 112. In one embodiment, three color-dependent geometric meshes 126 are generated for each projector 112, which include a first geometric mesh 126 for the red color band, a second geometric mesh 126 for the green color band, and a third geometric mesh 126 for the blue color band. Calibration unit 124 identifies the set of points for each color band of each projector 112 using the screen-to-camera triangle meshes and the color-dependent camera-to-projector triangle meshes as described in additional detail below.

Referring to FIG. 6B, frame generator 108 renders frames 110 for each projector 112 using the three respective color-dependent geometric meshes 126 for the projector 112, as indicated in a block 608. Frame generator 108 provides respective frames 110 to respective frame buffers 113 in respective projectors 112. Projectors 112 project respective frames 110 onto display surface 116 in partially overlapping positions as indicated in a block 610. Because each color-dependent geometric mesh 126 defines a mapping between display surface 116 and a frame buffer 113 of a respective projector 112, frame generator 108 uses color-dependent geometric meshes 126 to warp frames 102 (e.g., warping each color band of the frames individually) into frames 110, such that frames 110 appear spatially aligned and without chromatic aberrations when projected by projectors 112 as images 114 in partially overlapping positions on display surface 116. Frame generator 108 interpolates the pixel values for frames 110 using the color-dependent geometric meshes 126 as described in additional detail below.

FIGS. 2C and 2D (described above) illustrate a method for performing the function of block 602 of FIG. 6A. Namely, the method of FIGS. 2C and 2D illustrate one embodiment of generating screen-to-camera triangle meshes. The method of FIGS. 2C and 2D is described above with further reference to FIGS. 3A-3D.

FIG. 6C illustrates a method for performing the function of block 604 of FIG. 6A. Namely, the method of FIG. 6C illustrates one embodiment of generating color-dependent camera-to-projector triangle meshes. The method of FIG. 6C will be described with reference to FIGS. 4A-4D. The method of FIG. 6C is performed for each projector 112 to generate three color-dependent camera-to-projector triangle meshes for each projector 112.

In FIG. 6C, calibration unit 124 causes a projector 112 to display a set of known color patterns (e.g., known primary color patterns) on display surface 116 as indicated in a block 630. Calibration unit 124 provides a series of frames 110 with known color patterns to frame buffer 113 in projector 112 by way of frame generator 108. Projector 112 displays the series of known color patterns.

Camera 122 captures a set of images 123B (shown in FIG. 4A) of display surface 116 while the known color patterns are being projected onto display surface 116 by projector 112 as indicated in a block 632. The known color patterns may be any suitable color patterns that allow calibration unit 124 to identify points in the color patterns using images 123B captured by camera 122. In one embodiment, the known color patterns are a sequence of horizontal and vertical red-and-black bar patterns, green-and-black bar patterns, and blue-and-black bar patterns.

Calibration unit 124 locates points of the known color patterns in images 123B as indicated in a block 634. In FIG. 4A, points 400 represent the points in camera domain (C) 312 located by calibration unit 124 for one of the color bands. In one embodiment, a series of known color patterns (e.g., a red-and-black pattern image, a green-and-black pattern image, and a blue-and-black pattern image) are projected onto display surface 116, and calibration unit 124 separately locates points 400 for each color band in the manner described above with respect to FIG. 4A.

Calibration unit 124 generates a set of point correspondences 408(i) between the known color patterns (in the coordinate space of projector 112) and camera images 123B of these known color patterns as indicated in a block 636. Points 410(i) represent the ith points (where i is between 1 and N) in an ith projector domain (Pᵢ) 412(i) for a particular color band, which are identified in image 123B by calibration unit 124. The ith set of point correspondences 408(i) are represented by arrows that identify corresponding points in camera domain 312 and projector domain 412(i).

Calibration unit 124 determines color-dependent camera-to-projector triangle meshes using the set of correspondences 408(i) for each color band as indicated in a block 638. The color-dependent camera-to-projector triangle meshes are used to map color bands in the camera domain (C) 312 to the projector domain (Pᵢ) 412(i) and vice versa. Calibration unit 124 determines color-dependent camera-to-projector triangle meshes using the method illustrated in FIG. 2D (described above with reference to FIGS. 4B and 4C) for each color band.

Referring back to block 606 of FIG. 6A, calibration unit 124 generates color-dependent geometric meshes 126 for each projector 112 using the screen-to-camera meshes (block 602 and FIG. 2C) and the color-dependent camera-to-projector meshes for each projector 112 (block 604 and FIG. 6C). Each color-dependent geometric mesh 126 maps a color band from screen domain (S) 302 to a projector domain (Pᵢ) 412 and vice versa.

FIG. 6D illustrates a method for performing the function of block 606 of FIG. 6A. Namely, the method of FIG. 6D illustrates one embodiment of generating a color-dependent geometric mesh 126 that maps a color band from the screen domain to a projector domain of a projector 112. The method of FIG. 6D is performed for each color band (e.g., red, green, and blue) of each projector 112 to generate three color-dependent geometric meshes 126 for each projector 112.

Referring to FIG. 6D, for each color band of each projector 112, calibration unit 124 constructs a triangle mesh over a rectangular, evenly spaced grid that includes a set of points in the screen domain as indicated in a block 642. In one embodiment, the triangle mesh is constructed at 642 in the manner described above with reference to FIG. 2F and FIG. 5A. In other embodiments, the triangle mesh may be constructed over an arrangement of points other than rectangular, evenly-spaced grids. Delaunay triangulation or other suitable triangulation methods are used to construct a triangle mesh from the set of points.

For each color band of each projector 112, calibration unit 124 generates a set of point correspondences between the set of points in the screen domain and a set of points in the projector domain using the screen-to-camera mesh and the color-dependent camera-to-projector mesh for the projector 112 as indicated in a block 644. In one embodiment, the set of point correspondences is generated at 644 in the manner described above with reference to FIGS. 2G, 3D, and 4D.

For each color band of each projector 112, calibration unit 124 constructs a color-dependent geometric triangle mesh 126 in the projector domain that corresponds to the triangle mesh in the screen domain using the set of point correspondences as indicated in a block 646. In other embodiments, calibration unit 124 may first construct a triangle mesh in the projector domain, using Delaunay triangulation or other suitable triangulation methods, and then construct a triangle mesh in the screen domain using the set of point correspondences.

Referring back to block 608 of FIG. 6B, frame generator 108 renders frames 110 using respective color-dependent geometric meshes 126. FIG. 2H illustrates a method for mapping locations in frames 110 to locations in projector frame buffers 113 to allow the function of block 608 to be performed. The method of FIG. 2H is performed by frame generator 108 for each pixel in each frame 110 using the three color-dependent geometric meshes 126 to separately map the three color bands for the projector 112 that will project the rendered frame. The method of FIG. 2H is described above with reference to the example in FIG. 5B.

Some display systems may not be able to render images very efficiently if three separate color-dependent geometric meshes 126 are used for each projector 112. Thus, in another embodiment, rather than rendering images using three separate color-dependent geometric meshes 126, rendering is performed with a single geometric mesh with three sets of texture coordinates. In this embodiment, the three separate color-dependent geometric meshes 126 all warp to a common (e.g., green-channel) mesh, and thereby map the chromatically-differing mesh-distortions into a common target mesh.

One embodiment of display system 100 uses software to perform chromatic aberration correction, which is less expensive and potentially more accurate than optical correction solutions, and allows the system 100 to use a simpler optical design. In addition, the digital chromatic aberration correction provided by one embodiment allows for more flexibility in the design of projection systems using separate optical paths for the three colors.

Although the above methods contemplate the use of an embodiment of display system 100 with multiple projectors 112, the above methods may also be applied to an embodiment with a single projector 112. In addition, the above methods may be used to perform geometric correction and chromatic aberration correction on non-developable display surfaces.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method comprising:
generating a first plurality of meshes configured to map a first domain associated with a display surface to a second domain associated with an image capture device configured to capture a first image of the display surface;
generating a second plurality of meshes configured to map the second domain to a third domain associated with a first projector configured to display a second image onto the display surface; and
generating a third plurality of meshes using the first plurality of meshes and the second plurality of meshes, the third plurality of meshes configured to separately map a plurality of color bands between the first domain and the third domain.

2. The method of claim 1, and further comprising:
applying the third plurality of meshes to render a first image frame; and
projecting the first image frame with the first projector.

3. The method of claim 1, and further comprising:
providing a plurality of fiducial marks on the display surface;
locating the plurality of fiducial marks in the first image;
generating a set of point correspondences between the plurality of fiducial marks in the first image and the plurality of fiducial marks on the display surface; and
determining the first plurality of meshes from the set of point correspondences.

4. The method of claim 1, and further comprising:
capturing at least one image of at least one known color pattern projected on the display surface;
generating a set of point correspondences between the at least one known color pattern and the at least one known color pattern in the at least one captured image; and
determining at least one of the second plurality of meshes from the set of point correspondences.

5. The method of claim 4, wherein the at least one known color pattern comprises at least one of a red-and-black pattern, a green-and-black pattern, and a blue-and-black pattern.

6. The method of claim 1, wherein the plurality of color bands includes a red color band, a green color band, and a blue color band.

7. The method of claim 1, wherein the third plurality of meshes is configured to correct chromatic aberrations.

8. The method of claim 1, and further comprising:
generating at least one of the first plurality of meshes, the second plurality of meshes, and the third plurality of meshes using Delaunay triangulation.

9. The method of claim 1, and further comprising:
generating a fourth plurality of meshes configured to map the second domain to a fourth domain associated with a second projector configured to display a third image onto the display surface simultaneously with the display of the second image by the first projector; and
generating a fifth plurality of meshes using the first plurality of meshes and the fourth plurality of meshes, the fifth plurality of meshes configured to separately map a plurality of color bands between the first domain and the fourth domain.

10. A system comprising:
a frame generator configured to render a first image frame using a first plurality of meshes to generate a second image frame;
a first projector configured to store the second image frame in a first frame buffer and project the second image frame onto a display surface to display a first image; and
wherein the first plurality of meshes defines a first plurality of color-dependent mappings between the display surface and the first frame buffer.

11. The system of claim 10, wherein each mesh in the first plurality of meshes corresponds to a different color band in a plurality of color bands.

12. The system of claim 11, wherein the plurality of color bands include a red color band, a green color band, and a blue color band.

13. The system of claim 10, wherein the first plurality of meshes is configured to correct chromatic aberrations.

14. The system of claim 10, wherein the frame generator is configured to produce the second image frame by interpolating a first plurality of pixel values using the first plurality of meshes.

15. The system of claim 10, wherein the frame generator is configured to warp the first image frame using the first plurality of meshes to generate the second image frame.

16. The system of claim 10, wherein the frame generator is configured to render a third image frame using a second plurality of meshes to generate a fourth image frame, and wherein the system further comprises:
a second projector configured to store the fourth image frame in a second frame buffer and project the fourth image frame onto the display surface to display a second image such that the second image at least partially overlaps with the first image on the display surface; and
wherein the second plurality of meshes defines a second plurality of color-dependent mappings between the display surface and the second frame buffer.

17. The system of claim 10, wherein the display surface is a non-planar developable surface.

18. A computer-readable storage medium storing computer-executable instructions for performing a method comprising:
generating a first plurality of meshes based at least in part on a first image of a display surface;
generating a second plurality of color-dependent meshes from a first plurality of known color patterns and a first set of images that includes the first plurality of known color patterns, the first set of images captured from the display of the first plurality of color patterns on the display surface by a first projector; and
generating a third plurality of color-dependent meshes using the first plurality of meshes and the second plurality of color-dependent meshes, wherein the third plurality of color-dependent meshes defines a first plurality of color-dependent mappings between the display surface and the first projector.

19. The computer-readable medium of claim 18, wherein the first plurality of color-dependent mappings include a first mapping for a red color channel of the first projector, a second mapping for a green color channel of the first projector, and a third mapping for a blue color channel of the first projector.

20. The computer-readable medium of claim 18, wherein the method further comprises:
generating a fourth plurality of color-dependent meshes from the first plurality of known color patterns and a second set of images that includes the first plurality of known color patterns, the second set of images captured from the display of the first plurality of color patterns on the display surface by a second projector; and
generating a fifth plurality of color-dependent meshes using the first plurality of meshes and the fourth plurality of color-dependent meshes, wherein the fifth plurality of color-dependent meshes defines a second plurality of color-dependent mappings between the display surface and the second projector.
